(19) United States
(12) Patent Application Publication
(10) Pub. No.: US 2026/0195975 A1
(43) Pub. Date: Jul. 9, 2026

(54) CAMERA CONTROL FOR WORLD FOUNDATION MODELS

(71) Applicant: NVIDIA Corporation, Santa Clara, CA (US)

(72) Inventors: Chen-Hsuan Lin, Campbell, CA (US); Xiaohui Zeng, Toronto (CA); Tsung-Yi Lin, Sunnyvale, CA (US); Jingyi Jin, San Jose, CA (US); Ming-Yu Liu, Redwood City, CA (US)

(21) Appl. No.: 19/175,307

(22) Filed: Apr. 10, 2025

Related U.S. Application Data
(60) Provisional application No. 63/741,865, filed on Jan. 4, 2025.

(51) Int. Cl. G06T 15/20; G06T 13/20

(52) U.S. Cl. CPC G06T 15/20; G06T 13/20

(57) ABSTRACT

Neural network architectures and machine learning techniques that support camera control for a world foundation model (WFM), e.g., a WFM suitable for training Physical AI. In at least one embodiment, a system comprises processing circuitry to perform training and/or inferencing using one or more neural networks configured to receive camera parameters as input and to generate a video of a scene as viewed by a camera having a trajectory specified by the camera parameters as output. In at least one embodiment, embeddings corresponding to the input camera parameters are concatenated with visual tokens, and the expanded visual tokens are processed by the one or more neural networks.

### CLAIM OF PRIORITY

This application claims the benefit of U.S. Provisional Application No. 63/741,865, titled “Camera Control On World Foundation Models” and filed Jan. 4, 2025, the entire contents of which are incorporated herein by reference.

### FIELD

The present disclosure relates to neural network architectures and machine learning techniques that support camera control for a world foundation model (WFM), e.g., a WFM suitable for training Physical AI. In at least one embodiment, a system comprises processing circuitry to perform training and/or inferencing using neural networks configured to receive, as input, camera parameters and to generate, as output, a video of a scene as viewed by a camera having a trajectory specified by the input camera parameters.

### BACKGROUND

Physical AI is an AI system equipped with sensors and actuators: the sensors allow it to observe the world, and the actuators allow it to interact with and modify the world. Physical AI holds the promise of freeing human workers from physical tasks that are dangerous, laborious, or tedious. Over the past decade, an abundance of training data and compute have enabled rapid advances in several AI fields. The progress of Physical AI, however, has been slower-largely due to a lack of high-quality training data. Desired training data for Physical AI must contain sequences of interleaved observations and actions that perturb the physical world. However, such action may cause severe damage to both the Physical AI and its surroundings in the physical world. The risk of damage is particularly acute when the Physical AI is still in its infancy and exploratory actions are essential.

### BRIEF DESCRIPTION OF THE DRAWINGS

Subject matter of the present disclosure is described in detail below with reference to the attached drawing figures. Features described and/or illustrated herein can be used alone and/or combined in different combinations. The attached drawings illustrate the following:

FIG. 1A illustrates a block diagram of an example WFM suitable for use in implementing some embodiments of the present disclosure;

FIG. 1B illustrates a block diagram of an example pre-trained diffusion WFM suitable for use in implementing some embodiments of the present disclosure;

FIG. 1C illustrates a block diagram of an example transformer suitable for use in implementing some embodiments of the present disclosure;

FIG. 1D illustrates a block diagram of an example instruction-based logic suitable for use in implementing some embodiments of the present disclosure;

FIG. 2A illustrates a block diagram of an example fine-tuned WFM suitable for use in implementing some embodiments of the present disclosure;

FIG. 2B illustrates a block diagram of an example fine-tuning configuration suitable for use in implementing some embodiments of the present disclosure;

FIG. 2C illustrates a block diagram of an example fine-tuned WFM for providing camera control, in accordance with an embodiment of the present disclosure;

FIG. 2D illustrates a flowchart of a method for fine-tuning a pre-trained WFM for providing camera control, in accordance with an embodiment of the present disclosure;

FIG. 3A provides a qualitative comparison of a video generated by a camera-controllable WFM according to an embodiment of the present disclosure with a video generated by a state-of-the-art model for camera-controllable video generation;

FIG. 3B provides a quantitative comparison of a video generated by a camera-controllable WFM according to an embodiment of the present disclosure with a video generated by a state-of-the-art model for camera-controllable video generation;

FIG. 4 illustrates an example parallel processing unit suitable for use in implementing one or more embodiments of the present disclosure;

FIG. 5A is a conceptual diagram of a processing system implemented using the PPU of FIG. 4, suitable for use in implementing one or more embodiments of the present disclosure;

FIG. 5B illustrates an exemplary system in which the various architecture and/or functionality of the various previous embodiments may be implemented;

FIG. 5C illustrates components of an exemplary system that can be used to train and utilize machine learning, suitable for use in implementing one or more embodiments of the present disclosure; and

FIG. 6 illustrates an exemplary streaming system suitable for use in implementing one or more embodiments of the present disclosure.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implemented using large language models (LLMs), systems implemented using vision language models (VLMs), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in one or more embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In one or more embodiments, the inference microservice may include software to perform in-place replacement and/or updating to the machine learning model(s). When replacing or updating, the software that performs the replacement/updating may maintain user configurations of the inference runtime software and enterprise management software.

### World Foundation Models for Physical AI

Before being deployed in a real-world environment, Physical AI can be trained digitally. To do so, it is necessary to obtain a digital twin of the physical AI, the policy model, and a digital twin of the world (i.e., the world model). A world foundation model (WFM) is a general-purpose world model that can be fine-tuned into customized world models for downstream applications and used to build customized world models for Physical AI setups.

To build a pre-trained WFM, a large-scale video training dataset is used to expose the model to a diverse set of visual experiences so it can become a generalist. To build a post-trained WFM, the pre-trained WFM is fine tuned to arrive at a specialized WFM using a dataset collected from a particular Physical AI environment for the targeted, specialized Physical AI setup. Data determines the ceiling of an AI model. To build a high-ceiling pre-trained WFM, a video data curation pipeline may be used to construct the large-scale video training dataset by locating portions of videos with rich dynamics and high visual quality that facilitate learning of physics encoded in visual content. The video data curation pipeline extracts about 100 M clips of videos ranging from 2 to 60 seconds from a 20M hour-long video collection. For each clip, a visual language model (VLM) provides a video caption per 256 frames.

Pre-trained WFMs generate high-quality 3D consistent videos with accurate physics. Pre-trained WFMs are world model generalists that are trained with large-scale, diverse video datasets capturing different aspects of real-world physics and can be specialized to a target Physical AI setup through post-training.

Usually, the datasets for post-training are “prompt”-video pairs collected from the target Physical AI setup. The prompt can be in the form of action commands, trajectory, instructions, etc. As the pre-trained WFM provides a great foundation, the dataset for post-training can be much smaller. Post training the WFMs with specialized datasets enables them to be utilized in a wide range of Physical AI setups.

Transformer-based diffusion models are one scalable approach for building a pre-trained WFM. A diffusion model generates videos by gradually removing noise from a Gaussian noise video. Transformer-based diffusion models decompose a difficult video generation problem into easier sub-problems, making it more tractable. State-of-the-art transformer architectures may be leveraged for their scalability.

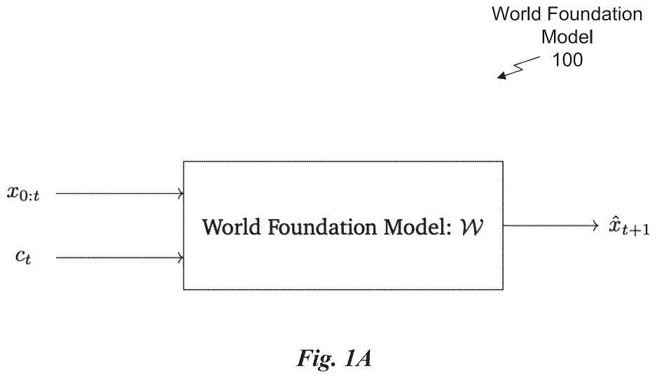

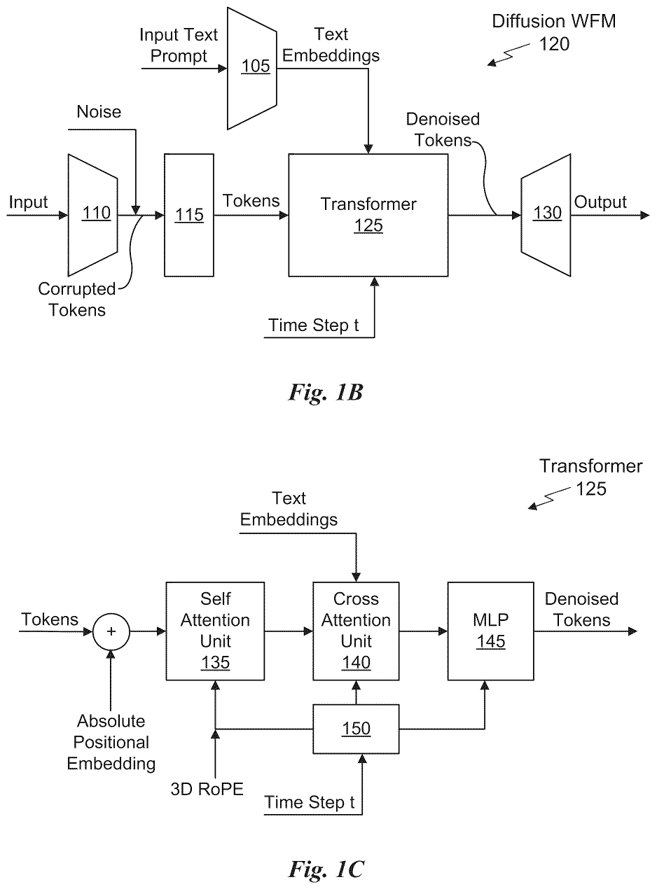

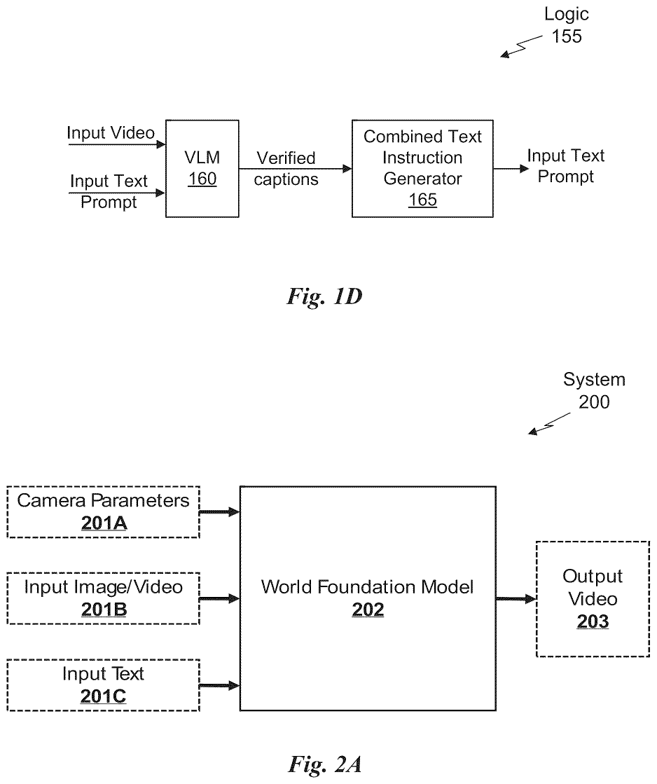

FIG. 1A illustrates a block diagram of an example WFM 100 suitable for use in implementing one or more embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the WFM 100 is within the scope and spirit of embodiments of the present disclosure.

WFM 100 is a model [symbol] that predicts a future observation \hat{x}ₜ₊₁ at time t+1 based on a sequence of visual observations x_{0:t} of the real world from time 0 to time t and a current perturbation cₜ. In one or more embodiments, the past observation x_{0:t} is a video, e.g., an RGB video, while the current perturbation cₜ is, e.g., an action taken by a physical AI, a random perturbation, a text description of the perturbation, and the like.

WFM 100 is useful to Physical AI builders in many ways, including, but not limited to, policy evaluation, policy initialization, policy training, planning or model-predictive control, and/or synthetic data generation. Policy evaluation refers to evaluating the quality of a policy model in a Physical AI system. Instead of evaluating a trained policy by deploying it to a Physical AI system operating in the real world, one could instead let the digital copy of the Physical AI system interact with WFM 100. The WFM-based evaluation is more cost-effective and time-efficient. WFM 100 enables builders to deploy the policy model in unseen environments that are otherwise unavailable. WFM 100 enables developers to rule out incapable policies quickly and focus physical resources on a few promising ones.

A policy model generates actions to be taken by the Physical AI system based on the current observations and the given task. WFM 100 models dynamic patterns of the world based on the input perturbations, and can serve to provide a good initialization of the policy model. This helps address the data scarcity problem in Physical AI. When paired with a reward model, WFM 100 can be a proxy for the physical world to provide feedback to the policy model in a reinforcement learning setup. An agent can gain proficiency in solving tasks by interacting with WFM 100.

WFM 100 can be used for planning or model-predictive control to simulate different future states following different action sequences taken by a Physical AI system. A cost/reward module can then be used to quantify the performance of the different action sequences based on the outcomes. The Physical AI can then execute the best action sequence based on the simulation results as a whole, as in planning algorithms or in a receding horizon manner, as in model-predictive control. The accuracy of the world model provides an upper bound for performance of the decision-making strategies. WFM 100 can be used to generate synthetic data for training. It can also be fine-tuned to be conditioned on rendering metadata such as depth or semantic maps.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

### Camera-Controllable World Foundation Models

The present disclosure provides neural network architectures and machine learning techniques that support camera control for world foundation models (WFMs). A camera-controllable WFM can generate 3D worlds, e.g., from a single reference input image and/or text, leveraging camera control to produce temporally coherent and 3D-consistent video simulations from specified camera trajectories, where changes in perspective align with the underlying 3D structure of the scene.

According to one or more embodiments, a novel architecture is provided for a diffusion-based WFM configured to receive, as input, both camera parameters (i.e., intrinsics, rotation, and translation) and an image/video and/or text and to generate, as output, a video, captured by a camera having a trajectory specified by the input camera parameters, of a scene corresponding to the input image and/or text. In at least one embodiment, the input layer of the novel architecture provides for input in the form of latent embeddings representing visual data concatenated with latent embeddings representing camera intrinsics. In at least one embodiment, the latent embeddings representing the camera intrinsics are Plücker embeddings.

According to one or more embodiments, a novel method is provided for fine-tuning a pre-trained WFM to instill the capability of generating, as output, a video, captured by a camera having a trajectory specified by input camera parameters, of a scene corresponding to the input image and/or text. In at least one embodiment, an embedding dimension of attention subblocks and multi-layer perceptron (MLP) subblocks of a neural network architecture of a pre-trained WFM is expanded to accommodate latent embeddings representing camera intrinsics. Parameters of parameter structures of the pretrained WFM are retained, and both the retained parameters and newly initialized parameters are simultaneously learned via fine-tuning.

According to one or more embodiments, a system includes processing circuitry configured to obtain a pre-trained world foundation model (WFM), generate a modified WFM, and fine-tune the modified WFM. The WFM is configured to process visual and/or textual input to generate an output video depicting a scene. The processing circuitry is configured to generate the modified WFM by expanding one or more parameter structures of the pretrained WFM to increase an embedding dimension thereof. The processing circuitry is configured to fine-tune the modified WFM by obtaining camera parameter fine-tuning input, the camera parameter fine-tuning input specifying a camera trajectory, obtaining visual and/or textual fine-tuning input, processing, by the modified WFM, the camera parameter fine-tuning input and the visual and/or textual fine-tuning input to generate a predicted video depicting a scene, as viewed by a camera having the camera trajectory, corresponding to the visual and/or textual fine-tuning input, and updating parameters of the modified WFM based on a comparison of the predicted video to a ground truth video. The system further includes one or more memories configured to store parameters of the pretrained WFM, parameters of the modified WFM, and the updated parameters.

According to an embodiment of the system, the generating the modified WFM further comprising adding, to the pretrained WFM, a concatenation block configured to concatenate visual tokens with camera parameter embedding vectors. According to an embodiment, the processing, by the modified WFM, the camera parameter fine-tuning input and the visual and/or textual fine-tuning input includes generating a sequence of noisy visual tokens corresponding to the visual and/or textual fine-tuning input, transforming the camera parameter fine-tuning input into a sequence of camera parameter embedding vectors, and concatenating individual noisy visual tokens with corresponding individual camera parameter embedding vectors to generate expanded noisy visual tokens, and denoising the expanded noisy visual tokens to provide a sequence of denoised tokens. According to an embodiment, the sequence of camera parameter embedding vectors is a sequence of Plücker embeddings. According to an embodiment, each Plücker embedding is a 6-dimensional Plücker coordinate computed, for a respective camera pose of the camera parameter fine-tuning input, as r=(d, m)∈ [symbol] , where m=c×d, c is a camera center location, and d is a unit ray direction. According to an embodiment, processing, by the modified WFM, the camera parameter fine-tuning input and the visual and/or textual fine-tuning input further includes decoding the sequence of denoised tokens to generate the predicted video.

According to an embodiment of the system, the pre-trained WFM is a diffusion-based WFM comprising a plurality of transformer blocks. According to an embodiment, each of one or more of the plurality of transformer blocks includes a respective self-attention subblock, a respective cross attention subblock, and a respective multi-layer perceptron (MLP) subblock. According to an embodiment, expanding one or more parameter structures of the pretrained WFM to increase an embedding dimension thereof comprises one or more of: expanding one or more weight matrices of the self-attention subblock of a first of the plurality of transformer blocks, expanding one or more weight matrices of the cross-attention subblock of the first of the plurality of transformer blocks, and/or expanding one or more weight matrices of the MLP subblock of the first of the plurality of transformer blocks.

According to an embodiment, the diffusion-based WFM further includes a tokenizer encoder and a tokenizer decoder. According to an embodiment, the tokenizer encoder is configured to generate a plurality of visual tokens in an embedding space that correspond to an input video, and the tokenizer decoder is configured to generate the output video by decoding a plurality of denoised visual tokens in the embedding space.

According to an embodiment, the system is one of: a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing remote operations, a system for performing real-time streaming, a system for generating or presenting one or more of augmented reality content, virtual reality content, or mixed reality content, a system implemented using an edge device, a system implemented using a robot, a system for performing conversational AI operations, a system implementing one or more language models, a system implementing one or more large language models (LLMs), a system implementing one or more vision language models (VLMs), a system implementing one or more multi-modal language models, a system for generating synthetic data, a system for generating synthetic data using AI, a system for performing one or more generative AI operations, a system incorporating one or more virtual machines (VMs), a system implemented at least partially in a data center, a system implemented at least partially using cloud computing resources, a system using or deploying one or more inference microservices, or a system that incorporates one or more machine learning models deployed in a service or microservice along with an OS-level virtualization package (e.g., a container).

According to one or more embodiments, a method is provided for generating a camera-controllable world foundation model (WFM). The method includes obtaining a pre-trained WFM configured to process visual and/or textual input to generate an output video depicting a scene, generating a modified WFM, and fine-tuning the modified WFM. The generating the modified WFM includes expanding one or more parameter structures of the pretrained WFM to increase an embedding dimension thereof. The fine-tuning the modified WFM includes obtaining camera parameter fine-tuning input, the camera parameter fine-tuning input specifying a camera trajectory, obtaining visual and/or textual fine-tuning input, processing, by the modified WFM, the camera parameter fine-tuning input and the visual and/or textual fine-tuning input to generate a predicted video depicting a scene, as viewed by a camera having the camera trajectory, corresponding to the visual and/or textual fine-tuning input and updating parameters of the modified WFM based on a comparison of the predicted video to a ground truth video.

According to an embodiment of the method, the generating the modified WFM further includes adding, to the pretrained WFM, a concatenation block configured to concatenate visual tokens with camera parameter embedding vectors. According to an embodiment, the processing, by the modified WFM, the camera parameter fine-tuning input and the visual and/or textual fine-tuning input includes generating a sequence of noisy visual tokens corresponding to the visual and/or textual fine-tuning input, transforming the camera parameter fine-tuning input into a sequence of camera parameter embedding vectors, concatenating individual noisy visual tokens with corresponding individual camera parameter embedding vectors to generate expanded noisy visual tokens, and denoising the expanded noisy visual tokens to provide a sequence of denoised tokens. According to an embodiment, the sequence of camera parameter embedding vectors is a sequence of Plücker embeddings. According to an embodiment, each Plücker embedding is a 6-dimensional Plücker coordinate computed, for a respective camera pose of the camera parameter fine-tuning input, as r=(d, m)∈ [symbol] , where m=c×d, c is a camera center location, and d is a unit ray direction. According to an embodiment of the method, the processing, by the modified WFM, the camera parameter fine-tuning input and the visual and/or textual fine-tuning input further includes decoding the sequence of denoised tokens to generate the predicted video.

According to an embodiment of the method, the pre-trained WFM is a diffusion-based WFM comprising a plurality of transformer blocks. According to an embodiment, each of one or more of the plurality of transformer blocks includes a respective self-attention subblock, a respective cross attention subblock, and a respective multi-layer perceptron (MLP) subblock. According to an embodiment, the expanding one or more parameter structures of the pretrained WFM to increase an embedding dimension thereof includes one or more of: expanding one or more weight matrices of the self-attention subblock of a first of the plurality of transformer blocks, expanding one or more weight matrices of the cross-attention subblock of the first of the plurality of transformer blocks, and/or expanding one or more weight matrices of the MLP subblock of the first of the plurality of transformer blocks.

According to an embodiment, the diffusion-based WFM further includes a tokenizer encoder and a tokenizer decoder. According to an embodiment, the tokenizer encoder is configured to generate a plurality of visual tokens in an embedding space that correspond to an input video, and the tokenizer decoder is configured to generate the output video by decoding a plurality of denoised visual tokens in the embedding space.

According to an embodiment of the method, at least one of the obtaining the pretrained WFM, generating the modified WFM, and the fine-tuning the modified WFM is performed within a cloud computing environment.

According to an embodiment of the method, at least one of the obtaining the pretrained WFM, generating the modified WFM, and the fine-tuning the modified WFM is performed for training, testing, or certifying a neural network for deployment in a machine, robot, or autonomous vehicle.

According to an embodiment of the method, at least one of the obtaining the pretrained WFM, generating the modified WFM, and the fine-tuning the modified WFM is performed on a virtual machine comprising a portion of a graphics processing unit.

According to an embodiment of the method, at least one of the obtaining the pretrained WFM, generating the modified WFM, and the fine-tuning the modified WFM is implemented to include advanced error correction, fault-tolerance, and self-healing capabilities.

According to an embodiment of the method, the method is performed by at least one of: a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing remote operations, a system for performing real-time streaming, a system for generating or presenting one or more of augmented reality content, virtual reality content, or mixed reality content, a system implemented using an edge device, a system implemented using a robot, a system for performing conversational AI operations, a system implementing one or more language models, a system implementing one or more large language models (LLMs), a system implementing one or more vision language models (VLMs), a system implementing one or more multi-modal language models, a system for generating synthetic data, a system for generating synthetic data using AI, a system for performing one or more generative AI operations, a system incorporating one or more virtual machines (VMs), a system implemented at least partially in a data center, a system implemented at least partially using cloud computing resources, a system using or deploying one or more inference microservices, or a system that incorporates one or more machine learning models deployed in a service or microservice along with an OS-level virtualization package (e.g., a container).

According to one or more embodiments, non-transitory computer-readable media is provided having stored thereon executable instructions that, when executed by processing circuitry, cause the processing circuitry to perform the method for generating a camera-controllable world foundation model (WFM) and any embodiment thereof.

A pre-trained WFM may be fine-tuned (or “post-trained”) to provide camera control capabilities. Pre-trained WFMs process video frames (observations) and a text prompt (perturbation) to generate an output video corresponding to future observations based on the video frames and text prompt. In one or more embodiments, the pre-training a diffusion-based WFM includes (i) text-to-world generation pre-training and (ii) video-to-world generation pre-training. Specifically, during the text-to-world pre-training, the model is trained to generate a video world based on input text prompt, and during the video-to-world pre-training, the model is fine-tuned to generate a future video world based on a past video and an input text prompt. The pre-trained WFM generates the output video while maintaining three-dimensional consistency and physics accuracy between the input video frames and each successive frame in the output video.

FIG. 1B illustrates a block diagram of an example pre-trained diffusion-based WFM 120, according to an embodiment. The pre-trained diffusion WFM 120 includes a text encoder 105, a tokenizer encoder 110, a 3D patchify block 115, one or more tailored transformer blocks 125, and a tokenizer decoder 130. In one or more embodiments, the one or more tailored transformer blocks 125 include N tailored, decoder-only, diffusion-based transformer blocks. Each tailored transformer block 125 includes sequential self-attention, cross-attention, and feedforward layers. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of WFM 120 is within the scope and spirit of embodiments of the present disclosure.

WFM 120 processes an input video through tokenizer encoder 110 to obtain latent representations (visual tokens), which are subsequently perturbed with Gaussian noise. The noisy latent representations (noisy tokens) are then transformed using a 3D patchification process implemented by 3D patchify block 115. An input text prompt is encoded into text embeddings by text encoder 105. In an embodiment, the text embeddings are zero padded to maintain a fixed sequence length of 512. In the latent space, tailored transformer block 125 applies repeated self-attention, cross attention (integrating text embeddings), and feed-forward multi-layer perceptron (MLP) operations, modulated by adaptive layer normalization (scale, shift, gate) for a given time step t. The tokenizer decoder 130 reconstructs the final video output from the refined latent representation.

Tokenizers are fundamental building blocks of modern large-scale models. WFM 120 process tokens (in the form of vectors) as representations of videos. Tokenizers transform raw data into more efficient representations by, e.g., learning a bottle-necked latent space discovered in an unsupervised manner. Specifically, visual tokenizers map raw and redundant visual data—such as images and videos—into compact semantic tokens for handling high-dimensional visual data. The transformation ability not only enables efficient training of large-scale transformer models but also democratizes their inference on limited computational resources.

Video contains rich information about the visual world. However, to facilitate learning of WFMs, videos are compressed into sequences of compact tokens while maximally preserving the original contents of the videos as the computational complexity of WFM training grows with the token counts. In many ways, building a video tokenizer is similar to building a video codec. In an embodiment, an attention-based encoder-decoder architecture is used to learn video tokenization for continuous and/or discrete tokens.

In an embodiment, the tokenizer (i.e., tokenizer encoder 110 and tokenizer decoder 130) is trained with a goal of producing a bottleneck token representation between tokenizer encoder 110 and tokenizer decoder 130 that maximally preserves visual information in an input image/video. Given an input image/video x_{0:T}∈ [symbol] , with H, W,T being the height, width, and one less than the number of frames, the tokenizer encoder 110 performs an encoding operation (ε) to transform the input image/video into a token image/video z_{0:T′}∈ [symbol] , with a spatial compression factor of

$${s}_{H W} = \frac{H}{{H}^{′}} = \frac{W}{{W}^{′}}$$

and a temporal compression factor of

$${s}_{T} = \frac{T}{{T}^{′}} .$$

The tokenizer decoder 130 then performs a decoding operation ( [symbol] ) to reconstruct the input video from the tokens, resulting in a reconstructed video \hat{x}_{0:T}∈ [symbol] . The operation of the tokenizer encoder 110 and the tokenizer decoder 130 can be represented mathematically as:

$${\hat{x}}_{0 : T} = 𝒟 ( ε ( {x}_{0 : T} ) ) .$$

In one or more embodiments, tokenizer encoder 110 and tokenizer decoder 130 employ a temporally causal design, ensuring that each stage processes only current and past frames, independent of future frames. In one or more embodiments, tokenizer encoder 110 and tokenizer decoder 130 implement causal operations, such that token computation for any current frame is not based on future observations. Such a causal design has several benefits. On the training side, joint image and video training is possible because a causal video tokenizer is also an image tokenizer when the input is a single image. The ability to process images enables autoregressive WFM 210 to leverage image datasets for training, which contain rich appearance information of the worlds and tend to be more diverse. On the application side, causal video tokenizers are better aligned with Physical AI systems that live in the causal world.

In one or more embodiments, tokenizer encoder 110 and tokenizer decoder 130 operate in the wavelet space, where inputs are first processed by a 2-level wavelet transform. Specifically, the wavelet transform maps the input video x_{0:T} in a group-wise manner to downsample the inputs, e.g., by a factor of four, along x, y, and t. The groups are formed as: {x₀, x_{1:4}, x_{5:8}, . . . , x_{(T-3):T}}→{g₀, g₁, g₂, . . . , g_{T/4}}. Subsequent stages within the tokenizer encoder 110 process the frames in a temporally causal manner as {g₀, g_{0:1}, g_{0:2}, . . . }→{ξ₀, ξ₁, ξ₂, . . . }. Successive stages within the tokenizer encoder 110 follow a similar scheme, finally outputting the tokens z_{0:T′}. The causal design helps adapt models built on top of the tokenizer to downstream Physical AI applications that often operate on a temporal causal setting. The wavelet transform enables operation on a more compact video representation that eliminates redundancies in pixel information, allowing the remaining layers to focus on more semantic compression. In an embodiment, the encoder-decoder structure includes a 3D Haar wavelet, causal residual, causal downsampling, and causal spatio-temporal attention subblocks. The tokenizer decoder 130 mirrors the structure of the tokenizer encoder 110, replacing downsampling with upsampling.

3D patchify block 115 receives noisy latent representations of shape T×C×H×W for both image and video data, with images differentiated by a video with a single frame. To prepare inputs to the tailored transformer block 125, the state is first “patchified” using a linear layer and subsequently flattened by the tailored transformer block 125. The patchify process involves projecting non-overlapping cubes of shape (pₜ,pₕ,p_{w}) into individual token inputs for the tailored transformer block 125. Consequently, after patchification, an image or video is reshaped into a one-dimensional, spatiotemporal sequence of length THW/(pₜpₕp_{w}). In an embodiment, pₜ=1, pₕ=p_{w}=2 is used for the tailored transformer block 125.

FIG. 1C illustrates a block diagram of a tailored transformer block 125 suitable for use in implementing some embodiments of the present disclosure. The tailored transformer block 125 includes a self-attention subblock 135, a cross attention subblock 140, a scale, shift, gate subblock 150, and a multi-layer perceptron (MLP) subblock 145. In an embodiment, the one-dimensional sequence of tokens input to the tailored transformer block 125 is summed with an absolute positional embedding. The scale, shift, gate block 150 performs adaptive layer normalization (AdaLN) for a given time step t. In an embodiment, each query Q and key K is normalized before the attention operation. In one or more embodiments, a Root Mean Square Normalization (RMSNorm) is performed using learnable scales for one or more self-attention and cross-attention subblocks within the tailored transformer block 125. In one or more embodiments, because the AdaLN layers account for a significant portion of the parameters while contributing negligibly to the computational complexity in terms of FLOPs, Low-Rank Adaptation (LoRA) is implemented to decompose the dense linear projections in the AdaLN layers into low-rank approximations. In an embodiment, the optimization achieves a 36% reduction in parameter count (from 11 billion to 7 billion parameters) while maintaining performance parity across all evaluation metrics, demonstrating the effectiveness of the parameter-efficient design.

The normalized time step is input to the self-attention subblock 135, the cross attention subblock 140, and the MLP subblock 145 (feedforward layers). The summed sequence, normalized time step, and 3D factorized Rotary Position Embedding (RoPE) are then processed by the self-attention subblock 135. In an embodiment, the absolute positional embedding and/or the 3D ROPE are learned during pre-training and may be fine-tuned during post training.

The 3D ROPE (as described by Jianlin Su, et al. in “Roformer: Enhanced transformer with rotary position embedding.” Neurocomputing, 2024) allows the generation of arbitrary size, aspect ratio, and video length. Specifically, the feature dimension is partitioned into three approximately equal chunks, each applying RoPE with positional information along the temporal, height, and width axes, respectively. In practice, this can be implemented efficiently without splitting and concatenation in each block by concatenating frequency embeddings in their respective axes and reusing RoPE kernels optimized for Large Language Models (LLMs). To further support video synthesis with varying frame rates, temporal frequencies can be rescaled based on the training video's Frames Per Second (FPS). Due to ROPE's relative positional encoding property and the 3D factorization design, the FPS-aware design is compatible with joint image-video training. An additional benefit of RoPE is evident during progressive training when image resolution or video length is altered. By leveraging Neural Tangent Kernel (NTK)-RoPE (as described by Bowen Peng and Jeffrey Quesnelle in “Ntk-aware scaled rope allows llama models to have extended (8k+) context size without any fine-tuning and minimal perplexity degradation,” 2023), rapid model convergence may be achieved, providing reasonable performance even within 5,000 training steps. Additionally, adding the learnable absolute positional embedding per tailored transformer block 125 can further enhance the WFM 120, reduce training loss, and reduce morphing artifacts in generated videos.

The cross-attention subblock 140 performs text conditioning on the text embeddings and incorporates linguistic information into the output of the self-attention subblock 135. While self-attention operates over spatiotemporal tokens, cross-attention integrates semantic context using text embeddings as keys and values, enabling effective text conditioning. MLP subblock 145 processes the output of the cross attention subblock 140 and the normalized time step using learned parameters to produce the denoised tokens.

As previously described, WFM 120 pre-training includes two steps: (i) text-to-world generation pre-training and (ii) video-to-world generation pre-training. Specifically, WFM 120 is first trained to generate a video world based on the input text prompt. Then, WFM 120 is trained to generate a future video world based on a past video and an input text prompt.

In an embodiment, to pre-train the WFM 120, the denoising score matching loss, evaluated at a noise level σ, defined as

$$ℒ ( {D}_{θ} , σ ) = {𝔼}_{{x}_{0} , n} [ {‖ {D}_{θ} ( {x}_{0} + n ; σ ) - {x}_{0} ‖}_{2}^{2} ] ,$$

is used, where x₀~p_{data} is a clean image or video sampled from the training set, n~ [symbol] (0, σ²I) is i.i.d. Gaussian noise, and De represents WFM 120, which is tasked with denoising the corrupted sample x₀+n. In an embodiment, the preconditioning design introduced in EDM is adhered to for parameterizing D_{θ}. The overall training loss is defined as a weighted expectation of [symbol] (D_{θ};σ) over the noise levels:

$$ℒ ( {D}_{θ} ) = {𝔼}_{σ} [ \frac{λ ( σ )}{{e}^{u ( σ )}} ℒ ( {D}_{θ} , σ ) + u ( σ ) ] ,$$

$$λ ( σ ) = \frac{( {σ}^{2} + {σ}_{d a t a}^{2} )}{{( σ \cdot {σ}_{d a t a} )}^{2}} , and$$

$$ln ( σ ) ∼ 𝒩 ( {P}_{m ean} , {P}_{s t d}^{2} ) ,$$

where the distribution of noise levels σ is controlled by hyperparameters Pₘₑₐₙ and P_{std}. σ_{data} is the standard deviation of the training data, and the weighting function λ(σ) ensures equal contribution of each noise level at the beginning of the training. However, as training progresses, this balance may deteriorate. To mitigate the deterioration issue, the optimization over various noise levels may be treated as a form of multi-task learning. In an embodiment, an uncertainty-based weighting approach is utilized by introducing u(σ) as a continuous uncertainty function quantifying the uncertainty for the denoising objective [symbol] (D_{θ}, σ) at noise level σ. In an embodiment, a simple MLP is used to parameterize u(σ) and minimize the overall loss [symbol] (D_{θ}) during training. Intuitively, the contribution of loss at noise level σ is weighted down if the diffusion WFM 120 is uncertain about the task, i.e., if u(σ) is high. At the same time, the diffusion WFM 120 is penalized for the uncertainty, encouraging u(σ) to be as low as possible.

In an embodiment, pre-training is accomplished using joint image and video training. To leverage the vast abundance of high-quality, diverse image datasets for training WFM 120, an alternating optimization strategy may be implemented that interleaves batches of image and video data. To facilitate cross-modal knowledge transfer between image and video domains, a domain-specific normalization scheme is adopted that aligns the latent distributions using sufficient statistics estimated independently for image and video data. The approach is motivated by the observation that reducing the distributional shift between image and video latent representations improves generation quality. Furthermore, non-stationary statistics across temporal and channel dimensions are observed in video latent representations. To address the heterogeneity, a normalization strategy is applied that applies frame-wise and channel-wise standardization to video latent representations, effectively encouraging the video latent representations to better approximate an isotropic Gaussian prior distribution.

Beyond cross-modality knowledge transfer, the normalization scheme provides an important theoretical benefit: scale invariance in the signal-to-noise ratio during training. Consider two zero-mean latent representations with different scales: one standardized to unit variance, and another with variance 4. When adding Gaussian noise [symbol] (0,σ²) to achieve a desired signal-to-noise ratio for the standardized representation, the noise is scaled to [symbol] (0,4σ²) for the unnormalized representation to maintain the same ratio. By standardizing all latent representations, consistent signal-to-noise ratios are ensured across different scales, facilitating model adaptation even when the underlying tokenizer is updated during training.

To maintain computational efficiency, image and video batch sizes are balanced to ensure comparable memory utilization across processors, such as graphics processing units (GPUs). However, the video batch denoising loss exhibits slower convergence compared to the image batch loss. The slower convergence may result from the inherent temporal redundancy in video frames, which results in smaller gradient magnitudes for video batches. In an embodiment, the convergence discrepancy is addressed by scaling the video batch noise levels by the square root of the frame count relative to image batch noise levels.

In an embodiment, WFM 120 is trained using a progressive training strategy. An initial stage involves training on videos and images at a resolution of 512 pixels, using videos composed of 57 frames. Subsequently, the resolution transitions to the target resolution of 720 pixels, increasing the video length to 121 frames. After pre-training on massive data, WFM 120 is fine-tuned on a high-quality subset for [symbol] (10k) iterations with a linearly decaying learning rate.

To accommodate content with varying aspect ratios, the data may be organized into five distinct buckets corresponding to ratios of 1:1, 3:4, 4:3, 9:16, and 16:9, assigning each image or video to the bucket with the closest aspect ratio. During training, each data parallel process group samples from one bucket, allowing different buckets across different parallel process groups. In an embodiment, longest-side resizing is implemented to maximally preserve the original content information described in the prompt. For batch processing, reflection padding is applied to missing pixels and the padding mask is supplied to the diffusion backbone, enabling precise control during inference.

In an embodiment, mixed-precision training is used during pre-training. Two copies of the model weights are maintained: one in 16-bit (binary fraction) bfloat (BF16) format and another in 32-bit floating-point (FP32) format. During the forward and backward passes, the BF16 weights are used to improve training efficiency, resulting in gradients and activations also in BF16 format. For parameter updates, the weights are updated in FP32 to ensure numerical stability. The updated FP32 parameters are then copied and cast to BF16 for the next iteration. To further stabilize training, in an embodiment, the loss of denoising score matching in Eq. (5) is scaled by a factor of 10. In an embodiment, beta (β₁, β₂) and e coefficients are lowered to significantly reduce loss spikes for an AdamW optimizer. Following the pre-training, WFM 120 is a generalist. To build a post-trained WFM, WFM 120 may be post trained to arrive at a specialized WFM using a dataset collected from a particular Physical AI environment for the targeted, specialized Physical AI setup.

Notably, as a text-to-image generator, WFM 120 excels in generating high-fidelity images even without guidance, a capability that may be attributed to pre-training using a high-quality training dataset. While classifier-free guidance typically promotes mode-seeking behavior for preferred visual content, careful data selection can achieve a similar effect. However, for video generation, the lack of comparable high-quality data leads to suboptimal results under low guidance settings. Consequently, higher guidance values may be used to produce satisfactory content in video-generation tasks.

Following the text-to-world generation pre-training, the pre-trained diffusion WFM 120 may be extended to support image and video conditioning by incorporating previous frame(s) into the generation process to complete Video2World generation pre-training. Specifically, the conditional frame(s) are concatenated with the generated frames along the temporal dimension. To improve robustness against variations in input frame(s) during inference, augmented noise is introduced to the conditional frames during training. In an embodiment, the sigma value for the augmented noise is sampled with Pₘₑₐₙ=−3.0, P_{std}=2.0. Additionally, the input to WFM 120 is concatenated along the channel dimension with a binary mask that distinguishes conditional frames from generated frames. The loss function excludes contributions from the locations of conditional frames, focusing exclusively on the generated output. To improve generalization, the number of conditional frames may be randomly varied during pre-training. During inference, WFM 120 can flexibly operate with either a single conditional frame (image) or multiple previous frames as input.

During pre-training, WFM 120 uses detailed video descriptions as input text prompts to produce high-quality videos. However, during inference, user prompts may vary in length, structure, and style, often being much shorter. To bridge this gap between training and inference text prompts, a prompt upsampler can be used to transform original input prompts into more detailed and enriched versions. The prompt upsampler can improve the prompts by adding more details and maintaining a consistent description structure, which leads to higher quality output.

In an embodiment, the main requirements for the prompt upsampler include fidelity to the input prompts, alignment with training distribution, and enhanced visual details. The upsampled prompt should faithfully preserve the key elements of the original user input, including the main characters, actions or motions, key attributes, and overall intent. The upsampled prompt should closely resemble the distribution of pre-training prompts of WFM 120 in terms of length, language structure, and style. The upsampled prompt should be designed to prompt WFM 120 to generate more accurate imagery.

FIG. 1D illustrates a block diagram of an example instruction-based logic 155 suitable for use in implementing some embodiments of the present disclosure. The instruction-based logic 155 is a prompt upsampler for text-to-world generation that includes a VLM 160 and a combined text instruction generator 165. For the instruction-based first operating mode, a curation process is used to generate a combined text instruction to replace the input text prompt (caption). The input text prompts are short and may not be accurate.

In an embodiment, to obtain paired data, that is, short prompts simulating user input and corresponding long prompts reflecting the distribution of training prompts, VLM 160 is used to generate short captions based on training long prompts and corresponding videos. The long-to-short data creation strategy is effective in (1) preserving the authentic video content and distribution from detailed training prompts of WFM 120 and (2) ensuring fidelity between the short and long prompts.

In an embodiment, VLM 160 processes the input video and input text prompt, generating captions for the input video frames, comparing the captions with the input text prompt, and outputting verified captions. In an embodiment, the input text prompt may be determined to be inaccurate and is discarded. In an embodiment, the input text prompt may be consistent with the captions and can be used to verify the captions. In an embodiment, the verified captions for each video frame include a single sentence instruction (30 words) and a more detailed paragraph (80-150 words) describing the instruction. Combined text instruction generator 165 constructs a curated combined text instruction including the sentence and detailed paragraph defining the instruction. Combined text instruction replaces the input text prompt to the text encoder 105 for the first mode.

### Fine-Tuning for Camera Control

Through camera pose conditioning, camera control can be integrated into a diffusion-based WFM, thereby providing an effective 3D world simulator.

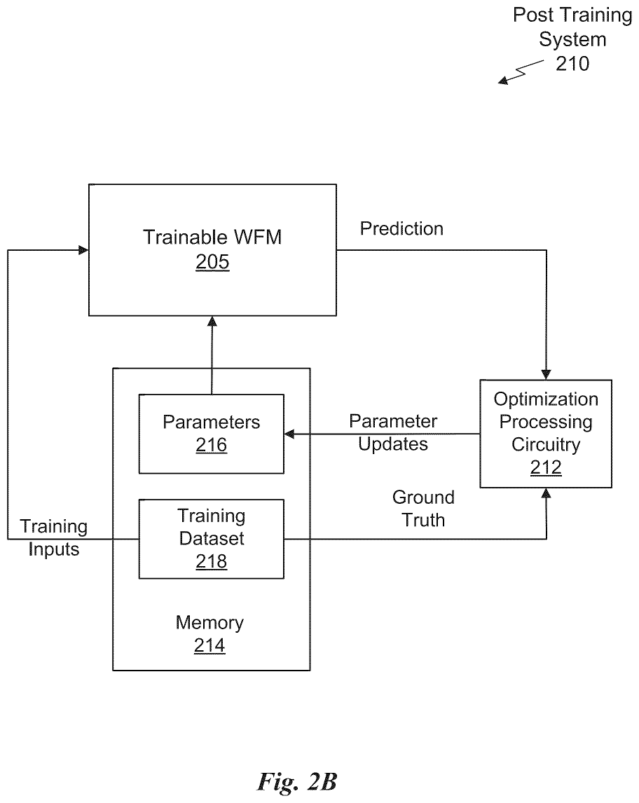

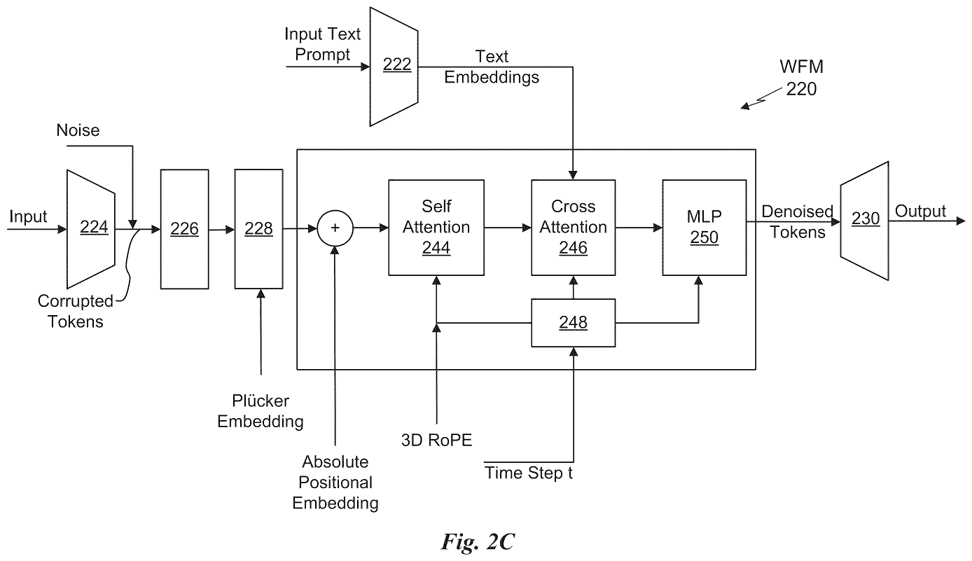

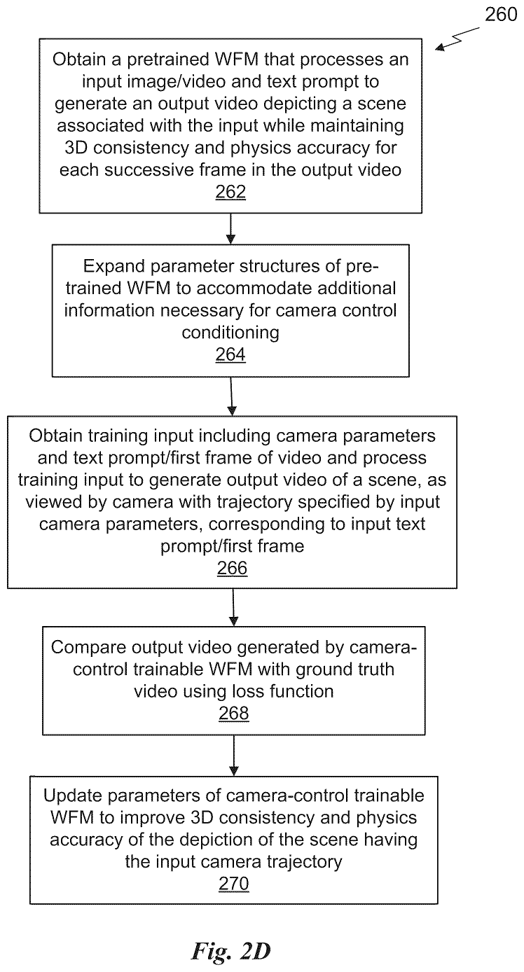

FIG. 2A illustrates a block diagram of an example system 200 suitable for use in implementing one or more embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of system 200 is within the scope and spirit of embodiments of the present disclosure.

System 200 includes a fine-tuned WFM 202 that exhibits camera controllability. Camera-controllable WFM 202 receives, as input, camera parameters 201A as well as image/video 201B and/or text 201C. Camera parameters 201A include camera intrinsics as well as camera rotation and camera translation for a series of timesteps (each corresponding to a single frame of output video 203). Camera-controllable WFM 202 processes (a) camera parameters 201A and (b) image/video 201B and/or text 201C, and generates, as output, (c) video 203. Output video 203 provides a sequence of view images (i.e., frames) corresponding to the perspective of a camera having the camera parameters 201A, of a scene corresponding to the input image 201B and/or text 201C.

In at least one embodiment, system 200 generates 3D worlds (in the form of output video 203) from a single reference input image (which can serve, e.g., as a first frame of video 203) or video (which can serve, e.g., as the first several (e.g., n) frames of video 203), leveraging camera control to produce temporally coherent and 3D-consistent video simulations from specified camera trajectories (i.e., camera trajectories corresponding to camera parameters 201A), where changes in perspective align with the underlying 3D structure of a scene.

In one or more embodiments, camera-controllable WFM 202 transforms camera parameters 201A into lower-resolution Plücker embeddings, which are a form of multi-channel images. The spatial dimensions of the Plücker embeddings are the same as the latent tokens. The Plücker embeddings are compatible with different video tokenizers. For tokenizers that encode all video frames as keyframes, Plücker embeddings can be concatenated to all frames. On the other hand, for tokenizers encoding keyframes followed by a number of predictive (residual) frames, Plücker embeddings can be concatenated to only the keyframes. Transforming camera parameters 201A into Plücker embeddings thereby enables camera control on a variety of WFM designs, enhancing flexibility.

In one or more embodiments, system 200 generates 3D worlds (in the form of output video 203) having real-world metric scale. Specifically, camera-controllable WFM 202 is configured to receive, as input, camera parameters 201A that are provided in real-world units (e.g., meters) and to generate, as output, video 203 corresponding to real-world metric scale camera rotation and translation.

FIG. 2B illustrates a block diagram of an example post-training system 210 suitable for use in implementing one or more embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of system 210 is within the scope and spirit of embodiments of the present disclosure.

Post-training system 210 may be used to train a trainable WFM 205, e.g., a trainable WFM initialized using the pre-trained diffusion-based WFM 120, to provide a camera-controllable WFM (e.g., camera-controllable WFM 202 of FIG. 2A). Post-training system 210 includes optimization processing circuitry 212 and a memory 214. Memory 214 stores parameters 216 of trainable WFM 205 and a training dataset 218. Training dataset 218 includes training samples in the form of videos with corresponding text and camera parameters. Trainable WFM 205 obtains training input (corresponding to a training sample) and generates a prediction. Optimization processing circuitry 212 compares the prediction generated by trainable WFM 205 to ground truth corresponding to the same training sample using a loss function and computes parameter updates for optimizing parameters 216 of trainable WFM 205. In one or more embodiments, the training input received by trainable WFM 205 is in the form of a combination of a first frame or the first n frames of a ground truth video and corresponding text and camera parameters, the prediction generated by trainable WFM 205 is in the form of a predicted video, and optimization processing circuitry 212 compares the predicted video to the ground truth video using the loss function. In one or more embodiments, the loss function is the diffusion loss or is based on the diffusion loss.

In one or more embodiments, training dataset 218 is curated. Training dataset 218 includes videos, a text caption associated with each video (e.g., as generated by using a video language model (VLM) to caption the video), and camera parameters (e.g., intrinsics, rotation, and translation) corresponding to each frame of the video. In one or more embodiments, the camera pose of the first frame is set to be the identity transform and the relative camera poses for subsequent frames are computed from depth data corresponding to each video. In one or more embodiments, the depth data is generated by applying an off-the-shelf video depth estimation algorithm, e.g., a structure-from-motion algorithm, e.g., GLOMAP (as described by Pan et al. in “Global Structure-From-Motion Revisited.” ECCV, 2025). In one or more embodiments, training dataset 218 includes videos having different resolutions, aspect ratios, and frame rates.

In one or more embodiments, training dataset is 218 is curated from the DL3DV-10K (as described by Ling et al. in “DL3DV-10K: A Large-Scale Scene Dataset for Deep Learning-Based 3D Vision.” CVPR, 2024) dataset, which is a large-scale video dataset of static scenes. To curate the training dataset 218, all videos are chunked into clips with 256 frames, and camera pose annotations for all frames within a clip are obtained via a structure-from-motion algorithm. In at least one embodiment, the structure-from-motion algorithm is GLOMAP. The camera pose of the first frame is set as the identity transform, and relative camera poses for all subsequent frames are computed using depth data provided by the structure-from-motion algorithm. In at least one embodiment, text prompts that describe the videos (and that correspond to the videos in the training dataset 218) are obtained using a video language model (VLM). In at least one embodiment, training is implemented using training samples in which input frames of the training videos are resized to 704×1252 and padded to 704×1280 with reflection.

In one or more embodiments, optimization processing circuitry 212 compares the predicted video to the ground truth video using the same loss function, training objective, and hyperparameters used for pre-training of diffusion-based WFM 120, i.e., for the Video2World generation pre-training process described above. Specifically, optimization processing circuitry 212 utilizes a denoising score matching loss, evaluated at a noise level σ, for comparing the predicted video to the ground truth video, defined as:

$$ℒ ( {D}_{θ} , σ ) = {𝔼}_{{x}_{0} , n} [ {‖ {D}_{θ} ( {x}_{0} + n ; σ ) - {x}_{0} ‖}_{2}^{2} ] ,$$

where x₀~p_{data} is the ground truth video, n~ [symbol] (0,σ²I) is i.i.d. Gaussian noise, and D_{θ} is the WFM 205, which is tasked with denoising the corrupted sample x₀+n. The overall training loss is defined as a weighted expectation of [symbol] (D_{θ};σ) over the noise levels:

$$ℒ ( {D}_{θ} ) = {𝔼}_{σ} [ \frac{λ ( σ )}{{e}^{u ( σ )}} ℒ ( {D}_{θ} , σ ) + u ( σ ) ] ,$$

$$λ ( σ ) = \frac{( {σ}^{2} + {σ}_{d a t a}^{2} )}{{( σ \cdot {σ}_{d a t a} )}^{2}} , and$$

$$ln ( σ ) ∼ 𝒩 ( {P}_{m ean} , {P}_{s t d}^{2} ) ,$$

where the distribution of noise levels σ is controlled by hyperparameters Pₘₑₐₙ and P_{std}. σ_{data} is the standard deviation of the training data, and the weighting function λ(σ) ensures equal contribution of each noise level at the beginning of the training. However, as training progresses, this balance may deteriorate. To mitigate the deterioration issue, the optimization over various noise levels may be treated as a form of multi-task learning. In an embodiment, an uncertainty-based weighting approach is utilized by introducing u(σ) as a continuous uncertainty function quantifying the uncertainty for the denoising objective [symbol] (D_{θ}, σ) at noise level σ. In an embodiment, a simple MLP is used to parameterize u(σ) and minimize the overall loss [symbol] (D_{θ}) during training. Intuitively, the contribution of loss at noise level σ is weighted down if the trainable WFM 205 is uncertain about the task, i.e., if u(σ) is high. At the same time, the trainable WFM 205 is penalized for the uncertainty, encouraging u(σ) to be as low as possible.

In one or more embodiments, optimization processing circuitry 212 and memory 214 are distributed across the multiple separate processing devices, and parameters 216 of trainable WFM 205, gradients, and optimizer states are sharded across the multiple separate processing devices. Each of the multiple separate processing devices manages the memory needed for processing its shard for efficient memory usage and bandwidth.

FIG. 2C illustrates a block diagram of an example camera-controllable WFM 220, in accordance with an embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the camera-controllable WFM 240 is within the scope and spirit of embodiments of the present disclosure.

Camera controllable WFM 220 (which can be, e.g., camera-controllable WFM 202 of FIG. 2A or trainable WFM 205 of FIG. 2B) includes a text encoder 222, a tokenizer encoder 224, a tokenizer decoder 230, a 3D patchify block 226, a concatenation block 228, and one or more tailored transformer blocks 240. In one or more embodiments, the one or more transformer blocks 240 include N tailored, decoder-only, diffusion-based transformer blocks 240. Each tailored transformer block 240 includes an element-wise addition subblock 242, a self-attention subblock 244, a cross attention subblock 246, a scale, shift, gate subblock 248, and a multi-layer perceptron (MLP) subblock 250. Each tailored transformer block 240 further includes a visual embedding input (for receiving visual tokens), a text embedding input (for receiving textual tokens generated by text encoder), an absolute positional embedding input, a 3D RoPE input, and a time step input.

In one or more embodiments, tokenizer encoder 224 and tokenizer decoder 230 are configured as and perform the operations, described above, of tokenizer encoder 110 and tokenizer decoder 130 of FIG. 1B, respectively. In one or more embodiments, text encoder 222 is configured as and performs the operations, described above, of text encoder 105 of FIG. 1B. In one or more embodiments, 3D patchify block 226 is configured as and performs the operations, described above, of 3D patchify block 115 of FIG. 1B. In one or more embodiments, each tailored transformer block 240 is configured as and performs the operations, described above, of a tailored transformer block 125 of FIG. 1B. In one or more embodiments, each of self-attention subblock 244, cross attention subblock 246, scale, shift, gate subblock 248, and MLP subblock 250 are configured as and perform the operations, described above, of self-attention subblock 135, cross attention subblock 140, scale, shift, gate subblock 150, and MLP subblock 145 of FIG. 1C, respectively.

Concatenation block 228 is configured to receive a sequence of Plücker embeddings (with an identical sequence dimension as the one-dimensional, spatiotemporal sequence of visual tokens output by 3D patchify block 226) and concatenate each Plücker embedding in the sequence with a corresponding visual token in the sequence of visual tokens output by 3D patchify block 226. In one or more embodiments, each Plücker embedding is a 6-dimensional Plücker coordinate computed, for a given camera pose (provided by camera parameters received as input by camera controllable WFM 220), via:

$$r = ( d , m ) ∈ {ℝ}^{6} where m = c \times d ,$$

where c is the camera center location and d is the unit ray direction of each latent pixel (as represented by a token in the sequence of visual tokens output by 3D patchify block 226). As a result of concatenating the Plücker embeddings with the visual tokens, the embedding dimension of each embedding vector processed by the first tailored transformer block 240 is increased by 6.

In one or more embodiments, the sequence is Plücker embeddings is formed by selecting a single Plücker embedding for a plurality of video frames so as to account for temporal compression performed by tokenizer encoder 224. For example, in an embodiment in which tokenizer encoder provides a temporal compression rate of 8×, the Plücker embedding for each 4^{th} frame of the 8 video frames that correspond to a respective visual token (i.e., latent embedding in the embedding space) can be concatenated with that respective visual token. Concatenation block 228 is compatible with different video tokenizers: for tokenizers encoding all frames as keyframes, Plücker embeddings can be concatenated to all frames; while for tokenizers encoding keyframes followed by a number of predictive (residual) frames, Plücker embeddings can be concatenated to only the keyframes. Camera control can thereby be implemented, via concatenation of Plücker embeddings, on a variety of WFM model architectures.

In one or more embodiments, camera controllable WFM 220 is generated by (i) obtaining a pre-trained WFM (e.g., WFM 120) including a plurality of transformer blocks with an embedding dimension d, (ii) expanding parameter structures (e.g., weight matrices of self attention subblocks, cross attention subblocks, and MLP subblocks) of the plurality of transformer blocks to increase the embedding dimension from d to d+6 (thereby enabling the transformer blocks to process the additional information provided by the 6-dimensional Plücker coordinates), thus providing a camera-control trainable WFM (e.g., trainable WFM 205), (iii) initializing new parameters of the expanded parameter structures, and (iv) performing an end-to-end fine-tuning process (post-training) to update the parameters of the plurality of transformer blocks of the camera-control trainable WFM and thereby provide a camera-controllable WFM (e.g., WFM 202 or WFM 220). In one or more embodiments, following the expansion of the parameter structures of the plurality of transformer blocks (but prior to the end-to-end fine-tuning), all parameters from the pre-trained WFM are retained and the new parameters of the expanded parameter structures are randomly initialized. In one or more embodiments, the new parameters of the expanded parameter structures are initialized via Xavier initializations (e.g., [torch.nn.init.xavier_uniform_(module.weight)]). In one or more embodiments, during the end-to-end fine-tuning to provide camera-controllable WFM 220, parameters of text encoder 222, tokenizer encoder 224, and tokenizer decoder 230 are frozen, while parameters of self-attention subblock 244, cross attention subblock 246, and MLP subblock 250 of one or more (e.g., each) tailored transformer blocks 240 are updated.

FIG. 2D illustrates a flowchart of a method 260 for fine-tuning a pre-trained WFM for providing camera control, in accordance with an embodiment of the present disclosure. Each block of method 260, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 260 is described, by way of example, with respect to the post-training system 210 of FIG. 2B and the camera-controllable WFM 220 of FIG. 2C. However, method 260 may additionally or alternatively be executed by any one system, or any combination of systems, including, but not limited to, those described herein. Furthermore, persons of ordinary skill in the art will understand that any system that performs method 260 is within the scope and spirit of embodiments of the present disclosure.

At 262, a pre-trained WFM is obtained that is configured to receive input (e.g., in the form of an image/video and/or a text prompt) and generate an output video depicting a scene associated with the input while maintaining 3D consistency and physics accuracy with the input image/video and each successive frame in the output video. In one or more embodiments, the pre-trained WFM is a diffusion model, including but not limited to the pre-trained diffusion WFM 120. In one or more embodiments, the pre-trained WFM includes a plurality of transformer blocks (that collectively form a transformer backbone) with an embedding dimension d.

At 264, parameter structures of the pre-trained WFM are expanded to accommodate additional information necessary for camera control conditioning. In one or more embodiments, the pre-trained WFM includes a sequence of transformer blocks that begins with a first transformer block. The first transformer block includes one or more of a self-attention subblock, a cross attention subblock, and an MLP subblock, and weight matrices thereof are expanded to provide for increasing the dimensionality of an embedding space thereof. As a result of the expansion of the parameter structures of the first transformer block of the pre-trained WFM, a camera-control trainable WFM is generated. In one or more embodiments, the dimensionality of the embedding space of the transformer blocks of the pre-trained WFM is d, and the weight matrices of one or more of a self-attention subblock, a cross attention subblock, and an MLP subblock of the first transformer block are expanded to provide an embedding space with dimensionality d+6. As a result, the dimensionality of the embedding space of the first transformer block of the transformer backbone of the camera-control trainable WFM is d+6, while the dimensionality of the embedding space of the remaining transformer blocks in the transformer backbone is d. In one or more embodiments, following the expansion of the parameter structures of the pre-trained WFM, all parameters from the pre-trained WFM are retained and the new parameters of the expanded parameter structures are randomly initialized. In one or more embodiments, the new parameters of the expanded parameter structures are initialized via Xavier initializations.

At 266, the camera-control trainable WFM obtains training input including both camera parameters and one or more of a text prompt and at least a first frame of a video (e.g., the first n frames of a video). The camera-control trainable WFM transforms the input camera parameters into lower-resolution Plücker embeddings and concatenates the Plücker embeddings with visual tokens. The camera-control trainable WFM then processes the resulting expanded visual tokens to generate an output video, which corresponds to a scene, as viewed by a camera with a trajectory specified by the input camera parameters, corresponding to the input text prompt and/or the at least the first frame of the video. At 268, the output video generated by the camera-control trainable WFM is compared with a ground truth video using a loss function. In one or more embodiments, the loss function is the diffusion loss or is based on the diffusion loss. At 270, parameters of the camera-control trainable WFM are updated to improve three-dimensional consistency and physics accuracy of the depiction of the scene having the input camera trajectory.

In an embodiment, at least one of steps 262, 264, 266, 268, or 270 is performed on a server or in a data center to generate the task video, and the task video is streamed to a user device. In an embodiment, at least one of steps 262, 264, 266, 268, or 270 is performed within a cloud computing environment. In an embodiment, at least one of steps 262, 264, 266, 268, or 270 is performed for training, testing, or certifying a neural network employed in a machine, robot, or autonomous vehicle. In an embodiment, at least one of steps 262, 264, 266, 268, or 270 is performed on a virtual machine comprising a portion of a graphics processing unit. In an embodiment, at least one of steps 262, 264, 266, 268, or 270 is implemented to include advanced error correction, fault-tolerance, and self-healing capabilities.

To evaluate the performance of a camera-controllable WFM according to an embodiment of the present disclosure, a single reference image is provided as input, and the camera-controllable WFM generates a video from the input image. The generated video is compared with a corresponding video generated by CamCo (as described by Xu et al. in “Camco: Camera-Controllable 3D-Consistent Image-to-Video Generation.” arXiv Preprint arXiv: 2406.02509, 2024), a state-of-the-art model for camera-controllable video generation. For a fair comparison, the camera-controllable WFM according to the embodiment of the present disclosure is compared with a CamCo model fine-tuned on the DL3DV-10K training set. As the camera-controllable WFM according to the embodiment of the present disclosure generates 57 frame videos and the CamCo model can only generate 14 frames, the comparison is based on the same 57-frame trajectories, which are temporally downsampled by 4×for the CamCo model.

For the performance evaluation, 500 samples from the RealEstate10K (as described by Zhou et al. in “Stereo Magnification: Learning View Synthesis Using Multiplane Images.” ACM Transactions on Graphics (TOG), 2018) were used. The initial frame of each video is used as an input image and camera trajectories provided by the dataset are used as camera control input. The camera control input is additionally rescaled such that distance between two ends of the trajectories is normalized to 1. The camera controllability is evaluated according to two aspects: video generation quality and 3D consistency. For video generation quality, the Fréchet Inception Distance (FID) and the Fréchet Video Distance (FVD) are used to assess the qualities at the frame and video levels, respectively. For 3D consistency, the ability of structure-from-motion libraries to re-estimate the camera poses is evaluated, and the results are compared against the input camera control trajectories. Given N frames in the video, the camera trajectory error is quantified into two terms: the average rotation error Erot and translation error Etrans, defined respectively as

$${ϵ}_{rot} = \frac{1}{N} {\sum }_{i = 1}^{N} {cos}^{- 1} ( \frac{trace ( {\hat{R}}_{i}^{⊤} {R}_{i} ) - 1}{2} ) , and$$

$${ϵ}_{trans} = \frac{1}{N} {\sum }_{i = 1}^{N} {‖ {\hat{t}}_{i} - {t}_{i} ‖}_{2} ,$$

where Rᵢ and tᵢ are the input rotation and translation of the i-th frame (serving as ground truth), and \hat{R}ᵢ and \hat{t}ᵢ are the re-estimated quantities. To account for ambiguities from camera pose estimation results up to a similarity transformation, Procrustes analysis is run on the predicted camera trajectories to align against the ground truth.

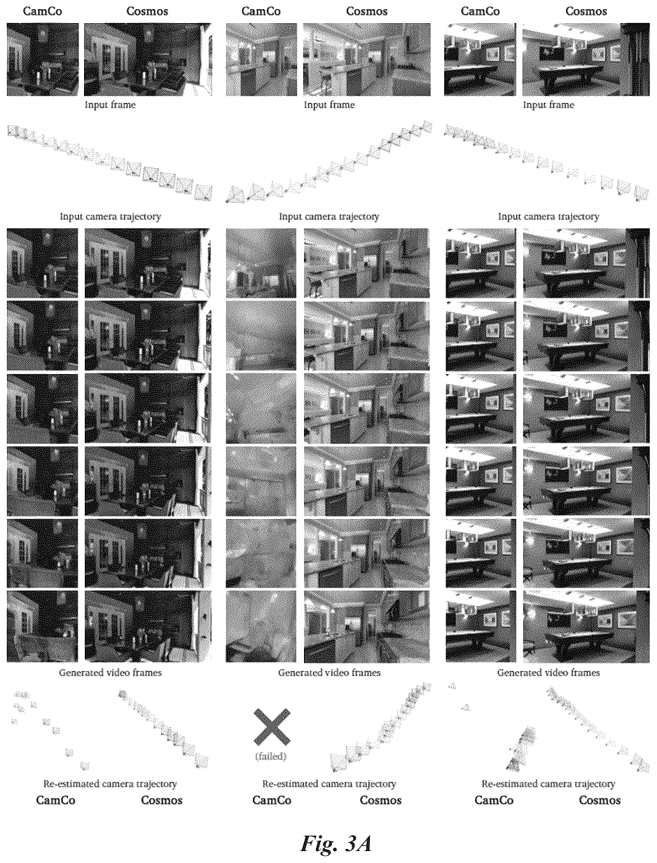

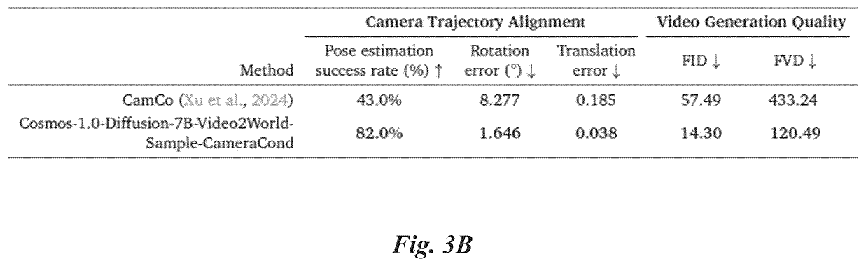

FIG. 3A provides a qualitative comparison of a video generated by a camera-controllable WFM according to an embodiment of the present disclosure with a video generated by a state-of-the-art model for camera-controllable video generation. Each model generates, given an input frame and an input camera trajectory, a sequence of future frames, and re-estimated camera poses are derived therefrom. As can be seen in FIG. 3A, the state-of-the-art model for camera-controllable video generation (i.e., “CamCo”) suffers from data distribution shift and often generates inaccurate trajectories or even out-of-distribution image syntheses that lead to un-estimable camera poses. In contrast, the camera-controllable WFM according to the embodiment of the present disclosure (i.e., “Cosmos”) successfully generates future frames aligned with the camera control input while simultaneously maintaining high video quality and 3D consistency.

FIG. 3B provides a quantitative comparison of a video generated by a camera-controllable WFM according to an embodiment of the present disclosure with a video generated by a state-of-the-art model for camera-controllable video generation. First, the camera-controllable WFM according to the embodiment of the present disclosure (i.e., “Cosmos”) generates realistic and coherent 3D worlds—as evidenced by the lower FID/FVD scores (higher visual quality) and the higher camera pose estimation success rate compared with those of the state-of-the-art model for camera-controllable video generation (i.e., “CamCo”).

### Parallel Processing Architecture

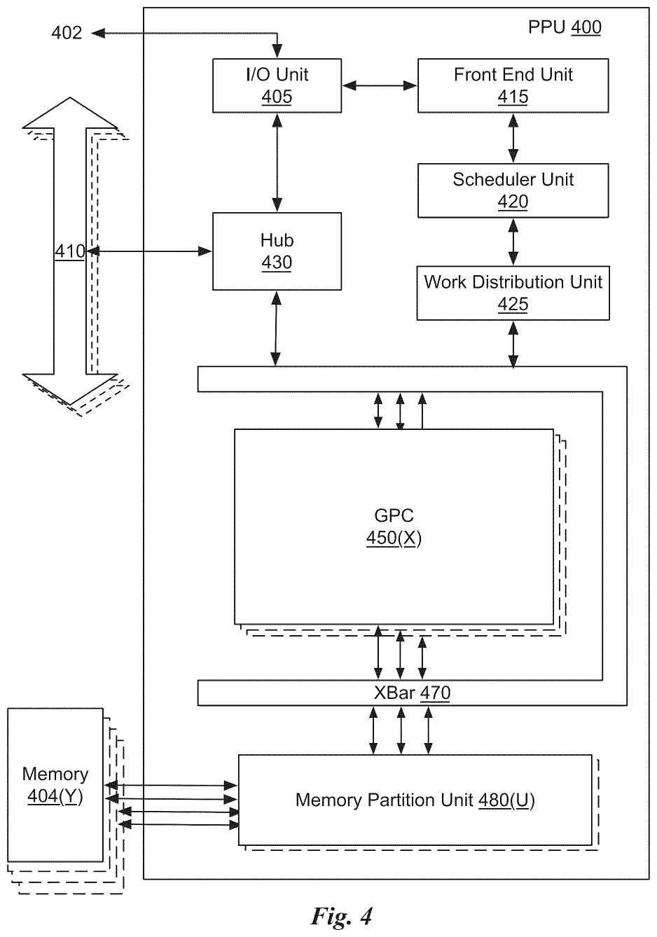

FIG. 4 illustrates a parallel processing unit (PPU) 400, in accordance with an embodiment. The PPU 400 may be used to implement the autoregressive WFM 210 and/or any one or more components thereof. The PPU 400 may also be utilized in training system 230. In an embodiment, a processor such as the PPU 400 may be configured to implement a neural network model. The neural network model may be implemented as software instructions executed by the processor or, in other embodiments, the processor can include a matrix of hardware elements configured to process a set of inputs (e.g., electrical signals representing values) to generate a set of outputs, which can represent activations of the neural network model. In yet other embodiments, the neural network model can be implemented as a combination of software instructions and processing performed by a matrix of hardware elements. Implementing the neural network model can include determining a set of parameters for the neural network model through, e.g., supervised or unsupervised training of the neural network model as well as, or in the alternative, performing inference using the set of parameters to process novel sets of inputs.

In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

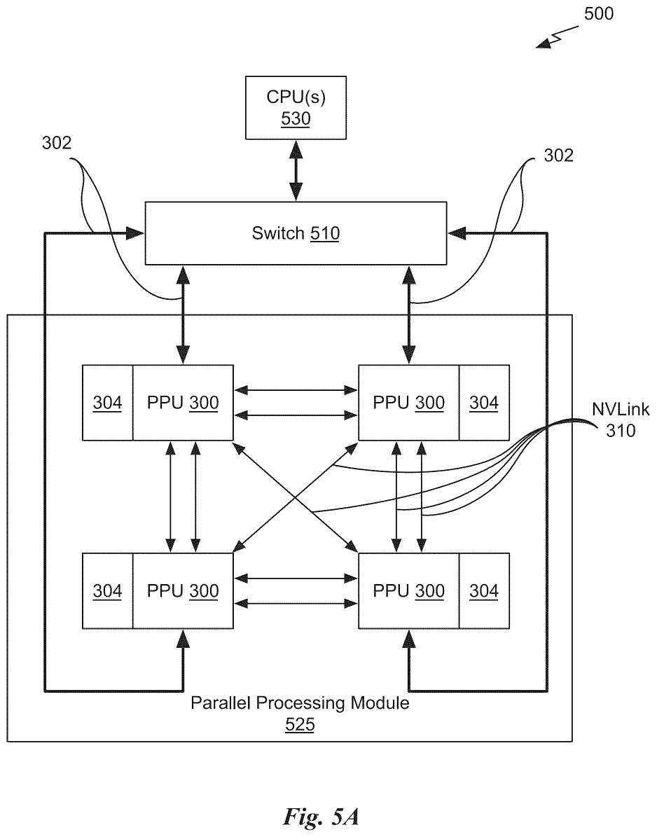

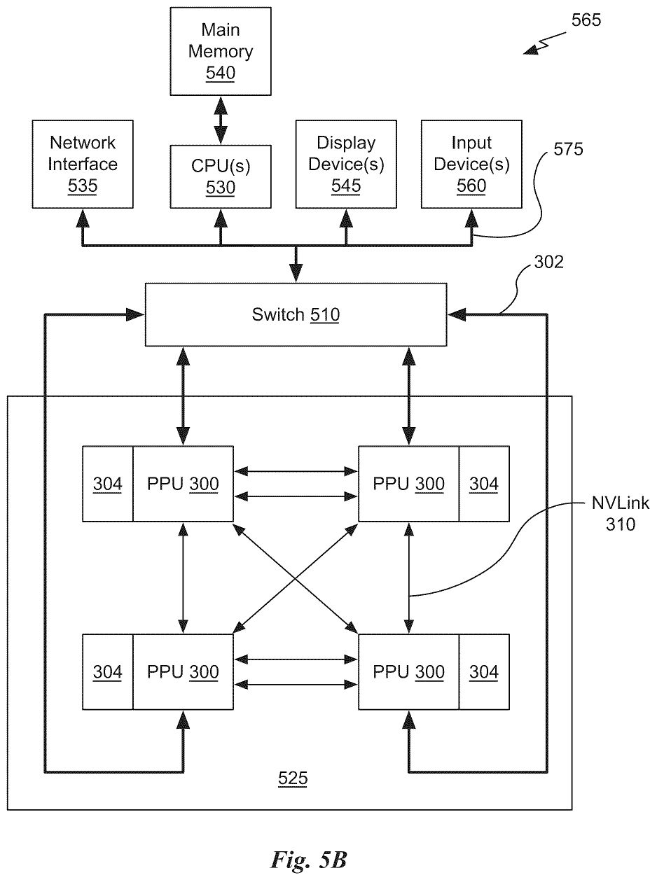

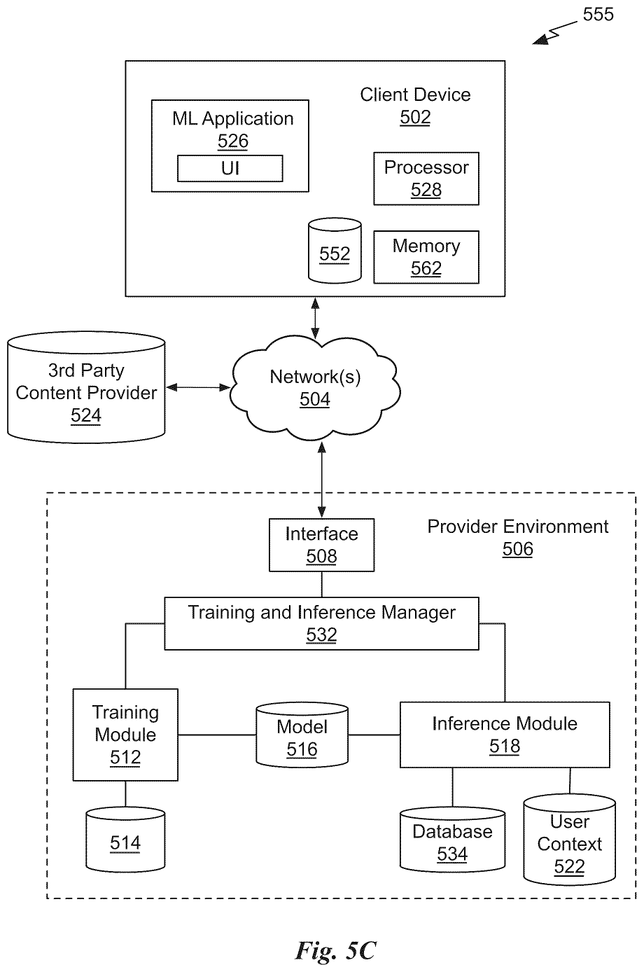

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QoS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in an L2 cache, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads ( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The exemplary system 500 may be configured, e.g., to implement method 240 shown in FIG. 2E. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented. The exemplary system 565 may be configured to implement method 240 shown in FIG. 2E.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In one or more embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5B are shown as connected via the communication bus 575 with lines, this is not intended to be limiting and is for clarity only. For example, in one or more embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5B is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5B.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5A and/or exemplary system 565 of FIG. 5B. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In an embodiment, the set of training data may be used in a generative adversarial training configuration to train a generator neural network. In at least one embodiment, training data can include images of at least one human subject, avatar, or character for which a neural network is to be trained. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In one or more embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

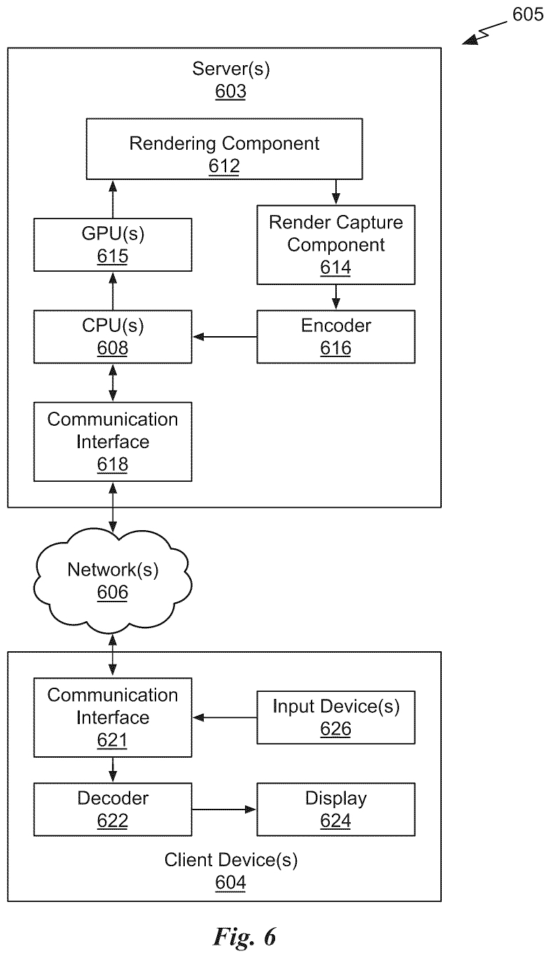

FIG. 6 is an example system diagram for a streaming system 605, in accordance with one or more embodiments of the present disclosure. FIG. 6 includes server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In one or more embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for one or more embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A method for generating a camera-controllable world foundation model (WFM), comprising:
obtaining a pre-trained WFM configured to process visual and/or textual input to generate an output video depicting a scene;
generating a modified WFM, the generating the modified WFM comprising expanding one or more parameter structures of the pretrained WFM to increase an embedding dimension thereof; and
fine-tuning the modified WFM by:
obtaining camera parameter fine-tuning input, the camera parameter fine-tuning input specifying a camera trajectory;
obtaining visual and/or textual fine-tuning input;
processing, by the modified WFM, the camera parameter fine-tuning input and the visual and/or textual fine-tuning input to generate a predicted video depicting a scene, as viewed by a camera having the camera trajectory, corresponding to the visual and/or textual fine-tuning input; and
updating parameters of the modified WFM based on a comparison of the predicted video to a ground truth video.

2. The method of claim 1, the generating the modified WFM further comprising adding, to the pretrained WFM, a concatenation block configured to concatenate visual tokens with camera parameter embedding vectors.

3. The method of claim 2, wherein the processing, by modified WFM, the camera parameter fine-tuning input and the visual and/or textual fine-tuning input comprises:
generating a sequence of noisy visual tokens corresponding to the visual and/or textual fine-tuning input;
transforming the camera parameter fine-tuning input into a sequence of camera parameter embedding vectors;
concatenating individual noisy visual tokens with corresponding individual camera parameter embedding vectors to generate expanded noisy visual tokens; and
denoising the expanded noisy visual tokens to provide a sequence of denoised tokens.

4. The method of claim 3, wherein the sequence of camera parameter embedding vectors is a sequence of Plücker embeddings.

5. The method of claim 4, wherein each Plücker embedding is a 6-dimensional Plücker coordinate computed, for a respective camera pose of the camera parameter fine-tuning input, as r=(d, m)∈ [symbol] , where m=c× d, c is a camera center location, and d is a unit ray direction.

6. The method of claim 3, wherein the processing, by the modified WFM, the camera parameter fine-tuning input and the visual and/or textual fine-tuning input further comprises:
decoding the sequence of denoised tokens to generate the predicted video.

7. The method of claim 1, wherein the pre-trained WFM is a diffusion-based WFM comprising a plurality of transformer blocks.

8. The method of claim 7, wherein one or more of the plurality of transformer blocks includes a respective self-attention subblock, a respective cross attention subblock, and a respective multi-layer perceptron (MLP) subblock.

9. The method of claim 8, wherein the expanding one or more parameter structures of the pretrained WFM to increase an embedding dimension thereof comprises one or more of:
expanding one or more weight matrices of the self-attention subblock of a first of the plurality of transformer blocks,
expanding one or more weight matrices of the cross-attention subblock of the first of the plurality of transformer blocks, and/or
expanding one or more weight matrices of the MLP subblock of the first of the plurality of transformer blocks.

10. The method of claim 7, the diffusion-based WFM further comprising a tokenizer encoder and a tokenizer decoder.

11. The method of claim 10, the tokenizer encoder being configured to generate a plurality of visual tokens in an embedding space that correspond to an input video, and
the tokenizer decoder being configured to generate the output video by decoding a plurality of denoised visual tokens in the embedding space.

12. The method of claim 1, wherein at least one of the obtaining the pretrained WFM, generating the modified WFM, and the fine-tuning the modified WFM is performed within a cloud computing environment.

13. The method of claim 1, wherein at least one of the obtaining the pretrained WFM, generating the modified WFM, and the fine-tuning the modified WFM is performed for training, testing, or certifying a neural network for deployment in a machine, robot, or autonomous vehicle.

14. The method of claim 1, wherein at least one of the obtaining the pretrained WFM, generating the modified WFM, and the fine-tuning the modified WFM is performed on a virtual machine comprising a portion of a graphics processing unit.

15. The method of claim 1, wherein at least one of the obtaining the pretrained WFM, generating the modified WFM, and the fine-tuning the modified WFM is implemented to include advanced error correction, fault-tolerance, and self-healing capabilities.

16. The method of claim 1, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system implemented at least partially in a data center;
a system implemented at least partially using cloud computing resources;
a system using or deploying one or more inference microservices;
a system that incorporates one or more machine learning models deployed in a service or microservice along with an OS-level virtualization package (e.g., a container).

17. A system, comprising:
processing circuitry configured to:
obtain a pre-trained world foundation model (WFM) configured to process visual and/or textual input to generate an output video depicting a scene,
generate a modified WFM, the generating the modified WFM comprising expanding one or more parameter structures of the pretrained WFM to increase an embedding dimension thereof,
fine-tune the modified WFM by:
obtaining camera parameter fine-tuning input, the camera parameter fine-tuning input specifying a camera trajectory,
obtaining visual and/or textual fine-tuning input,
processing, by the modified WFM, the camera parameter fine-tuning input and the visual and/or textual fine-tuning input to generate a predicted video depicting a scene, as viewed by a camera having the camera trajectory, corresponding to the visual and/or textual fine-tuning input, and
updating parameters of the modified WFM based on a comparison of the predicted video to a ground truth video; and
one or more memories configured to store parameters of the pretrained WFM, parameters of the modified WFM, and the updated parameters.

18. The system of claim 17, the generating the modified WFM further comprising adding, to the pretrained WFM, a concatenation block configured to concatenate visual tokens with camera parameter embedding vectors.

19. The system of claim 18, wherein the processing, by the modified WFM, the camera parameter fine-tuning input and the visual and/or textual fine-tuning input comprises:
generating a sequence of noisy visual tokens corresponding to the visual and/or textual fine-tuning input;
transforming the camera parameter fine-tuning input into a sequence of camera parameter embedding vectors;
concatenating individual noisy visual tokens with corresponding individual camera parameter embedding vectors to generate expanded noisy visual tokens; and
denoising the expanded noisy visual tokens to provide a sequence of denoised tokens.

20. The system of claim 19, wherein the sequence of camera parameter embedding vectors is a sequence of Plücker embeddings.

21. The system of claim 20, wherein each Plücker embedding is a 6-dimensional Plücker coordinate computed, for a respective camera pose of the camera parameter fine-tuning input, as r=(d, m)∈ [symbol] , where m=c× d, c is a camera center location, and d is a unit ray direction.

22. The system of claim 19, wherein the processing, by the modified WFM, the camera parameter fine-tuning input and the visual and/or textual fine-tuning input further comprises:
decoding the sequence of denoised tokens to generate the predicted video.

23. The system of claim 17, wherein the pre-trained WFM is a diffusion-based WFM comprising a plurality of transformer blocks.

24. The system of claim 23, wherein one or more of the plurality of transformer blocks includes a respective self-attention subblock, a respective cross attention subblock, and a respective multi-layer perceptron (MLP) subblock.

25. The system of claim 24, wherein the expanding one or more parameter structures of the pretrained WFM to increase an embedding dimension thereof comprises one or more of:
expanding one or more weight matrices of the self-attention subblock of a first of the plurality of transformer blocks,
expanding one or more weight matrices of the cross-attention subblock of the first of the plurality of transformer blocks, and/or
expanding one or more weight matrices of the MLP subblock of the first of the plurality of transformer blocks.

26. The system of claim 23, the diffusion-based WFM further comprising a tokenizer encoder and a tokenizer decoder.

27. The system of claim 26, the tokenizer encoder being configured to generate a plurality of visual tokens in an embedding space that correspond to an input video, and
the tokenizer decoder being configured to generate the output video by decoding a plurality of denoised visual tokens in the embedding space.

28. A non-transitory computer-readable media storing computer-executable instructions for generating a camera-controllable world foundation model (WFM) that, when executed by one or more processors, cause the one or more processors to perform the steps of:
obtaining a pre-trained WFM configured to process visual and/or textual input to generate an output video depicting a scene;
generating a modified WFM, the generating the modified WFM comprising expanding one or more parameter structures of the pretrained WFM to increase an embedding dimension thereof; and
fine-tuning the modified WFM by:
obtaining camera parameter fine-tuning input, the camera parameter fine-tuning input specifying a camera trajectory;
obtaining visual and/or textual fine-tuning input;
processing, by the modified WFM, the camera parameter fine-tuning input and the visual and/or textual fine-tuning input to generate a predicted video depicting a scene, as viewed by a camera having the camera trajectory, corresponding to the visual and/or textual fine-tuning input; and
updating parameters of the modified WFM based on a comparison of the predicted video to a ground truth video.

29. The non-transitory computer-readable media of claim 28, the generating the modified WFM further comprising adding, to the pretrained WFM, a concatenation block configured to concatenate visual tokens with camera parameter embedding vectors.

30. The non-transitory computer-readable media of claim 29, wherein the processing, by modified WFM, the camera parameter fine-tuning input and the visual and/or textual fine-tuning input comprises:
generating a sequence of noisy visual tokens corresponding to the visual and/or textual fine-tuning input;
transforming the camera parameter fine-tuning input into a sequence of camera parameter embedding vectors;
concatenating individual noisy visual tokens with corresponding individual camera parameter embedding vectors to generate expanded noisy visual tokens; and
denoising the expanded noisy visual tokens to provide a sequence of denoised tokens.
